(19) United States
(12) Patent Application Publication
(10) Pub. No.: US 2018/0152969 A1
(43) Pub. Date: May 31, 2018

(54) METHOD OF TRIGGERING A LBT RANDOM BACKOFF MECHANISM IN LTE LAA

(71) Applicant: ALCATEL LUCENT, Boulogne-Billancourt (FR)

(72) Inventors: Tao Tao, Shanghai (CN); Jianguo Liu, Shanghai (CN); Feng Han, Shanghai (CN); Yan Meng, Shanghai (CN); Sigen Ye, Whitehouse Station, NJ (US); Junrong Gu, Shanghai (CN); Dandan Wang, New Providence, NJ (US); Gang Shen, Shanghai (CN)

(73) Assignee: ALCATEL LUCENT, Boulogne-Billancourt (FR)

(21) Appl. No.: 15/575,085

(22) PCT Filed: May 12, 2016
(86) PCT No.: PCT/IB2016/000754

§ 371 Date: Nov. 17, 2017

(30) Foreign Application Priority Data
May 18, 2015 (CN) 201510253971.1

(51) Int. Cl. H04W 74/08; H04W 28/02; H04L 12/26

(52) U.S. Cl. CPC H04W 74/0841; H04W 28/0289; H04L 5/0055; H04L 43/0823; H04L 43/16

(57) ABSTRACT

The present invention provides a method of triggering a LBT random backoff mechanism in LTE LAA, the method comprising: evaluating a current channel to obtain a first parameter characterizing a congestion state of the current channel; comparing the first parameter with a first threshold to obtain a first comparison result; and adapting a contention window size based on the first comparison result. The method further comprises comparing the first parameter with a second threshold to obtain a second comparison result; and adapting the contention window size based on the second comparison result. The first parameter is a packet error rate metric or a collision metric. The method inventively uses the comparison between a first parameter characterizing a congestion state of the current channel and a predefined threshold to increase or decrease the contention window size correspondingly, such that not only the fairness problem with other Systems, a WiFi System, for example, is guaranteed, the usage efficiency of the communication resource and the performance of the whole wireless communication System will be also enhanced.

### FIELD OF THE INVENTION

The present disclosure generally relates to wireless communication, and particularly to a method of triggering a LBT (listen before talk) random backoff mechanism in LTE LAA (License Assisted Access).

### BACKGROUND OF THE INVENTION

In 3GPP, it is being studied the feasibility of using LTE on unlicensed spectrum and how to ensure the fair coexistence between LTE on unlicensed spectrum and other technologies on the same spectrum such as Wi-Fi. In RAN1 #78bis meeting, it was agreed that Listen-before-talk (LBT) is one of the identified functionalities required to meet regulatory requirements in some regions/bands for an

LAA system. In RAN1 #80 meeting, four LBT schemes were categorized for LAA channel access.
Category 1: No LBT;
Category 2: LBT without random back-off;
Category 3: LBT with random back-off with fixed size of contention window;
Category 4: LBT with random back-off with variable size of contention window.

FBE-based channel access as described in “ETSI EN 301 893 V1.8.0 (2015-01), Harmonized European Standard, “Broadband Radio Access Networks (BRAN); 5 GHz high performance RLAN” is one example of LBT category 2. With FBE-based channel access, each device performs CCA check at fixed time instants. If the channel is sensed busy, the device will have to wait till the next fixed period for another channel sensing opportunity. Hence, when LAA and Wi-Fi coexist on the same channel, FBE based access has less channel access opportunity compared to Wi-Fi and can result in the prolonged channel access delay for LAA eNBs, especially in high load situations.

LBE procedure with a fixed size of contention window (i.e. option B in EN 301 893 V1.8.0) belongs to LBT category 3. For this channel access, the device is allowed to perform (e)CCA at any time whenever there is a traffic demand.

In RAN1 #80bis meeting, working assumptions for LBT category 4 were agreed. “If LAA is adopting a LBT category 4 scheme for DL transmission, it will be based on ETSI option B modified to a LBT category 4 scheme except for the some modifications that ensure fairness with Wi-Fi.” The whole procedure of LBT category 4 is very similar to WiFi's distributed coordination function (DCF) mechanism. Different from category 3 with fixed contention window size, the size of the LAA contention window is variable via dynamic exponential backoff or semi-static backoff. The purpose of introducing the LBT category 4 is to ensure the medium access fairness for LAA and Wi-Fi. In LBT category 4, one issue that needs to be solved for LTE is what triggering mechanism to be used to adapt the contention window size.

Since the design target of LAA is not to impact Wi-Fi services more than an additional Wi-Fi network, the backoff trigger event should be carefully designed to achieve fairness with Wi-Fi in unlicensed spectrum. Furthermore, the trigger event and relative parameters should be standardized in LTE specifications.

In the prior art, in “R1-152326, Discussion on LBT Protocols, Ericsson Inc., RAN1 #80bis, April 2015”, it was proposed that the contention window is doubled when the latest ACK/NAK is negative (NAK), and it is reset to the minimum value when the latest ACK/NAK is positive (ACK). This is essentially the same as the approach used in Wi-Fi. However, if there are multiple UEs being scheduled in one subframe, this approach cannot be directly used.

In “R1-150978, Description of candidate LBT schemes, Huawei, HiSilicon, RAN1 LAA ad hoc meeting, March 2015”, the trigger is defined based on the ACK/NAK statistics in the latest channel occupancy time. One example is to double the contention window size when the NAK rate is higher than a certain threshold. The ACK/NAK based approach uses ACK/NAK as an indicator of the collision on the channel. However, ACK from retransmission may not correctly reflect that the collision has not occurred due to combining gain from hybrid automatic repeat request (HARQ).

The above schemes cannot effectively trigger and properly define or configure the contention window size.

### SUMMARY OF THE INVENTION

In order to overcome the technical problem described in the background, that is the drawback in the prior art, the inventors of the present invention provide a method for how to adjust the trigger time of the contention window so as to adapt to the contention with other communication systems on the same unlicensed spectrum.

Based on the above consideration, the present application provides a method of triggering a LBT random backoff mechanism in LTE LAA, the method comprising:
evaluating a current channel to obtain a first parameter characterizing a congestion state of the current channel;
comparing the first parameter with a first threshold to obtain a first comparison result; and
adapting a contention window size based on the first comparison result.

The method according to the present invention can evaluate the congestion state of the current channel firstly and thus obtain a first parameter characterizing the congestion state of the current channel. Then, the contention window size is adapted properly by comparing with a predefined threshold.

In one embodiment of the present invention, the contention window size is increased correspondingly, when the first parameter is greater than the first threshold.

Since the contention window would be increased, the collusion possibility of each contending nodes is reduced correspondingly. Since the collusion possibility is reduced, the communication performance of the whole wireless communication system is enhanced.

In one embodiment of the present invention, the contention window size is increased exponentially or linearly, when the first parameter is greater than the first threshold.

It should be appreciated for those skilled in the art, increasing the contention window size exponentially or linearly is merely exemplary, not limited. Those skilled in the art can modify it, such that the adaption of the contention window size can be achieved advantageously.

In one embodiment of the present invention, the method further comprises:
comparing the first parameter with a second threshold to obtain a second comparison result; and
adapting the contention window size based on the second comparison result.

Though this manner, not only an upper limit is set, but also a lower limit is set accordingly, such that the contention window size would be also adapted when it is below the lower limit, so as to adapt this kind of wireless communication system more purposefully.

In one embodiment of the present invention, the contention window size is decreased correspondingly, exponentially or linearly, or reset to a minimum value, when the first parameter is lower than the second threshold.

It should be appreciated for those skilled in the art, increasing the contention window size exponentially or linearly is merely exemplary not limited. Those skilled in the art can modify it, such that the adaption of the contention window size can be achieved advantageously.

In one embodiment of the present invention, the first parameter is a packet error rate metric or a collision metric.

The inventor of the present invention inventively introduces a packet error rate metric and a collision metric as a first parameter, such that the parameter for adapting the contention window size can be generated by using the current data with an easy manner.

In one embodiment of the present invention, when the first parameter is the packet error rate metric, the packet error rate is related to a ratio between the number of received NACK and the sum of the number of the received NACK and the number of received ACK from the first transmission.

With this manner, the inaccurate impact, which results from the ACK feedback due to the combining gain from a HARQ system, on the whole channel evaluation will be excluded. Thus, the packet error rate metric calculated in this way would be more persuaded and reflect the congestion state of the current channel more accurately.

In one embodiment of the present invention, the packet error rate metric is not only related to a statistic result of the last transmission but also related to weighted historical information.

In one embodiment of the present invention, the first threshold and/or the second threshold is a set value agreed by multiple operators or is related to initial BLER of each operator.

In one embodiment of the present invention, when the first parameter is the collision metric, the collision metric is related to the number of contending node and current contention window size of each contending node.

In one embodiment of the present invention, the number of contending nodes is equal to the number of the busy slots between two corresponding transmission bursts plus 1.

In one embodiment of the present invention, the number of the busy slots between two corresponding transmission bursts only includes busy slots, the length of which is greater than or equal to a first predefined length; or busy slots, the length of which is greater than or equal to a second predefined length, are adjusted by a predefined adjust factor for counting.

In one embodiment of the present invention, the number of the busy slots is related to the number of the busy slots between two corresponding transmission bursts and a random number used in eCCA.

In one embodiment of the present invention, the contention window size is its own contention window size, or a function of the contention window sizes of all the nodes communicating with it.

In one embodiment of the present invention, when the number of contending node is N and the current contending window size is q, the collision metric c is calculated by the following equations:

c=1−(1−1/q)^{N-1}

The method according to the present invention inventively uses the comparison between a first parameter characterizing a congestion state of the current channel and a predefined threshold to increase or decrease the contention window size correspondingly, such that not only the fairness problem with other systems, a WiFi system, for example, is guaranteed, the usage efficiency of the communication resource and the performance of the whole wireless communication system will be also enhanced.

The protection scope of the scheme of the present invention is defined by the appended claim set. Those skilled in the art can combine the different features, and make proper modification which is not apart from the conception of the present invention. Those are falling within the scope of the present invention. The technical scheme of the present invention would be discussed in detail with respect to figures.

### BRIEF DESCRIPTION OF DRAWINGS

Other features, objects and advantages of the invention will become more apparent upon review of the following detailed description of non-limiting embodiments taken with reference to the drawings in which:

FIG. 1 shows a flowchart 100 of a method of triggering a LBT random backoff mechanism in LTE LAA;

FIG. 2 shows a schematic diagram of the channel state at one contending node.

In the drawings, identical or like reference numerals denote identical or corresponding components or features throughout the different figures.

### DETAILED DESCRIPTION OF EMBODIMENTS

The below described particular description of preferred embodiments will be given with reference to the drawings constituting a part of the invention. The drawings exemplarily illustrate particular embodiments, in which the invention can be practiced. The exemplary embodiments are not intended to exhaust all the embodiments of the invention. As can be appreciated, other embodiments can be possible or structural or logical modifications can be made without departing from the scope of the invention. Thus the following detailed description is not intended to be limiting, and the scope of the invention will be defined as in the appended claims.

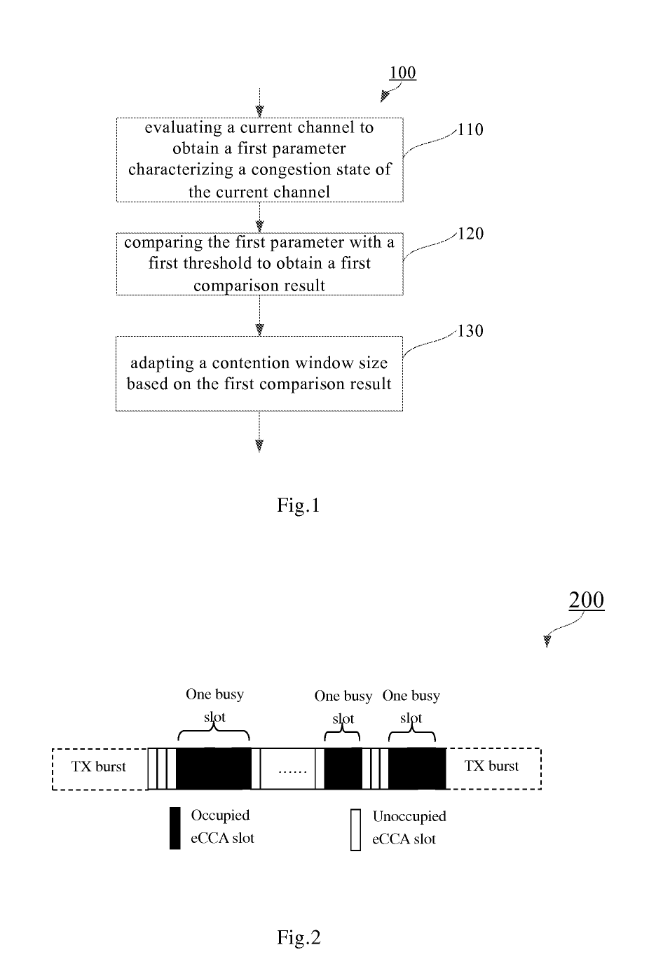

The present application provides a method of triggering a LBT random backoff mechanism in LTE LAA. FIG. 1 shows a flowchart 100 of a method of triggering a LBT random backoff mechanism in LTE LAA. As shown in FIG. 1, the method comprises the following steps:

Firstly, in method step 110, the current channel will be evaluated to obtain a first parameter characterizing a congestion state of the current channel.

Then, in method step 120, the first parameter is compared with a first threshold to obtain a first comparison result.

Finally, in method step 130, a contention window size is adapted based on the first comparison result.

The method according to the present invention can evaluate the congestion state of the current channel firstly and thus obtain a first parameter characterizing the congestion state of the current channel. Then, the contention window size is adapted properly by comparing with a predefined threshold.

In one embodiment of the present invention, the contention window size is increased correspondingly, when the first parameter is greater than the first threshold.

Since the contention window would be increased, the collusion possibility of each contending nodes is reduced correspondingly. Since the collusion possibility is reduced, the communication performance of the whole wireless communication system is enhanced.

In one embodiment of the present invention, the contention window size is increased exponentially or linearly, when the first parameter is greater than the first threshold.

It should be appreciated for those skilled in the art, increasing the contention window size exponentially or linearly is merely exemplary not limited. Those skilled in the art can modify it, such that the adaption of the contention window size can be achieved advantageously.

In one embodiment of the present invention, the method further comprises:
comparing the first parameter with a second threshold to obtain a second comparison result; and
adapting the contention window size based on the second comparison result.

Though this manner, not only an upper limit is set, but also a lower limit is set accordingly, such that the contention window size would be also adapted when it is below the lower limit, so as to adapt this kind of wireless communication system more purposefully.

In one embodiment of the present invention, the contention window size is decreased correspondingly, exponentially or linearly, or reset to a minimum value, when the first parameter is lower than the second threshold.

It should be appreciated for those skilled in the art, increasing the contention window size exponentially or linearly is merely exemplary not limited. Those skilled in the art can modify it, such that the adaption of the contention window size can be achieved advantageously.

In one embodiment of the present invention, the first parameter is a packet error rate metric or a collision metric.

The inventor of the present invention inventively introduces a packet error rate metric and a collision metric as a first parameter, such that the parameter for adapting the contention window size can be generated by using the current data with an easy manner.

In one embodiment of the present invention, when the first parameter is the packet error rate metric, the packet error rate is related to a ratio between the number of received NACK and the sum of the number of the received NACK and the number of received ACK from the first transmission. Specifically, the packet error rate metric, PER, for example can be calculated through the following equation:

PER=number of NACK/(number of NACK+number of ACK of non-HARQ retransmission).

With this manner, the inaccurate impact, which results from the ACK feedback due to the combining gain from a HARQ system, on the whole channel evaluation will be excluded. Thus, the packet error rate metric calculated in this way would be more persuaded and reflect the congestion state of the current channel more accurately.

In one embodiment of the present invention, the packet error rate metric is not only related to a statistic result of the last transmission but also related to weighted historical information.

For example, a can be introduced into the abovementioned PER calculation equation, so as to reflect the congestion state of the current channel more accurately.

PER(t)=(1−α)×PER(t)+α×PER(t−1).

Wherein the parameter a can be adjusted dynamically according to the feedback situation.

In one embodiment of the present invention, when the first parameter is the collision metric, the collision metric is related to number of contending node and current contention window size of each contending node.

In one embodiment of the present invention, the number of contending node is equal to the number of the busy slots between two corresponding transmission bursts plus 1.

In one embodiment of the present invention, the number of the busy slots between two corresponding transmission bursts only includes busy slots, the length of which is greater than or equal to a first predefined length; or busy slots, the length of which is greater than or equal to a second predefined length, are adjusted by a predefined adjust factor for counting.

FIG. 2 shows a schematic diagram of the channel state at one contending node.

As shown in the Figure, white blocks show unoccupied eCCA slots, and there are three busy slots in the all slots between the two TX bursts. Herein, three contending nodes which contend with it can be determined in the simplest way.

In one embodiment of the present invention, the number of the busy slots is related to the number of the busy slots between two corresponding transmission bursts and a random number used in eCCA.

In one embodiment of the present invention, the contention window size is its own contention window size, or a function of the contention window sizes of all the nodes communicating with it.

In one embodiment of the present invention, when the number of contending node is N and the current contending window size is q, the collision metric c is calculated by the following equations:

c=1−(1−1/q)^{N-1}

In one embodiment of the present invention, the first threshold and/or the second threshold is a set value agreed by multiple operators or is related to initial BLER of each operator.

For example, for the solution of the packet error rate metric, each operator can agree that the above threshold should be 12%, for example, since the initial BLER for LTE PHY link adaptation of each operator is normally controlled below 10%. The packet error rate metric larger than 12% could be thought as unacceptable, and the contention window size is needed to be increased, thereby the packet error rate metric can be reduced to an acceptable range. On the other hand, if each operator cannot approve such an agreement, the above threshold can be adapted to the different target initial BLER level of the LTE operators.

In the collision metric-based solution, it is normally assumed that one contending node is acceptable, and three or above contending nodes are unacceptable. At this time, the first and second threshold can be set as:

1−(1−1/15)³=18.7%; and

1−(1−1/15)=6.67%.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Those skilled in the art shall appreciate that the invention apparently will not be limited to the foregoing exemplary embodiments and can be embodied in other specific forms without departing from the spirit or essence of the invention. Accordingly the embodiments shall be construed anyway to be exemplary and non-limiting. Moreover apparently the term “comprising” will not preclude another element(s) or step(s), and the term “a” or “an” will not preclude plural. A plurality of elements stated in an apparatus claim can alternatively be embodied as a single element. The terms “first”, “second”, etc., are intended to designate a name but not to suggest any specific order.

The above depiction of the present disclosure is to enable any of those skilled in the art to implement or use the present invention. For those skilled in the art, various modifications of the present disclosure are obvious, and the general principle defined herein may also be applied to other transformations without departing from the spirit and protection scope of the present invention. Thus, the present invention is not limited to the examples and designs as described herein, but should be consistent with the broadest scope of the principle and novel characteristics of the present disclosure.

1. A method of triggering a LBT random backoff mechanism in LTE LAA, the method comprising:
evaluating a current channel to obtain a first parameter characterizing a congestion state of the current channel;
comparing the first parameter with a first threshold to obtain a first comparison result; and
adapting a contention window size based on the first comparison result.

2. A method according to claim 1, wherein the contention window size is increased correspondingly, when the first parameter is greater than the first threshold.

3. A method according to claim 2, wherein the contention window size is increased exponentially or linearly, when the first parameter greater than the first threshold.

4. A method according to claim 1, wherein the method further comprises:
comparing the first parameter with a second threshold to obtain a second comparison result; and
adapting the contention window size based on the second comparison result.

5. A method according to claim 4, wherein the contention window size is decreased correspondingly, exponentially or linearly, or reset to a minimum value, when the first parameter is lower than the second threshold.

6. A method according to claim 1, wherein the first parameter is a packet error rate metric or a collision metric.

7. A method according to claim 6, wherein when the first parameter is the packet error rate metric, the packet error rate is related to a ratio between the number of received NACK and the sum of the number of the received NACK and the number of received ACK from the first transmission.

8. A method according to claim 7, wherein the packet error rate metric is not only related to a statistic result of the last transmission but also related to weighted historical information.

9. A method according to claim 6, wherein when the first parameter is the collision metric, the collision metric is related to the number of contending node and the current contention window size of each contending node.

10. A method according to claim 9, wherein the number of contending nodes is equal to the number of the busy slots between two corresponding transmission bursts plus 1.

11. A method according to claim 10, wherein the number of the busy slots between the two corresponding transmission bursts only includes busy slots, the length of which is greater than or equal to a first predefined length; or busy slots, the length of which is greater than or equal to a second predefined length, are adjusted by a predefined adjust factor for counting.

12. A method according to claim 9, wherein the number of the busy slots is related to the number of the busy slots between two corresponding transmission bursts and a random number used in eCCA.

13. A method according to claim 9, wherein the contention window size is its own contention window size, or a function of the contention window sizes of all the nodes communicating with it.

14. A method according to claim 9, wherein when the number of contending node is N and the current contending window size is q, the collision metric c is calculated by the following equations:
c=1−(1−1/q)^{N-1}.

15. A method according to claim 1, wherein the first threshold and/or the second threshold is a set value agreed by multiple operators or is related to initial BLER of each operator.
